(19) United States
(12) Patent Application Publication
(10) Pub. No.: US 2006/0213738 A1
(43) Pub. Date: Sep. 28, 2006

(54) Powertrain clutch

(75) Inventors: George G. Moser, Brighton, MI (US); Gordon Sommer, Plymouth, MI (US); Adam Ostapowicz, Westland, MI (US)

Correspondence Address: HARNESS, DICKEY & PIERCE, P.L.C., P.O. BOX 828, BLOOMFIELD HILLS, MI, 48303, US

(73) Assignee: Automotive Powers Systems,LLC, Auburn Hills, MI (US)

(21) Appl. No.: 10/565,947

(22) PCT Filed: Aug. 3, 2004
(86) PCT No.: PCT/US04/24839

§ 371 Date: Jan. 26, 2006

Related U.S. Application Data
(60) Provisional application No. 60/493,594, filed on Aug. 8, 2003.

(51) Int. Cl. F16D 27/08; F16D 47/00

(52) U.S. Cl. 192/21.5; 192/48.2; 192/48.3; 192/57

(57) ABSTRACT

A powertrain clutch for transferring power from an output shaft of an engine to an input shaft of a manual transmission includes a housing and an electrically controlled clutch between the input shaft and the output shaft for selectively coupling and uncoupling the output shaft and the input shaft. The clutching arrangement further includes a clutch disposed between the input shaft and the output shaft for synchronizing a speed of the input shaft with a speed of the output shaft.

### CROSS-REFERENCE TO RELATED APPLICATION

This application claims priority to U.S. Provisional Patent Application No. 60/493,594 filed Aug. 8, 2003 and to PCT/US04/24839 filed Aug. 3, 2004 and published as WO 2005/017382 on Feb. 24, 2005, which applications are expressly incorporated herein by reference.

### INTRODUCTION

With a conventional manual transmission, an operator controlled clutch pedal is depressed for selectively disengaging the transmission from a source of drive torque (typically the engine) in order to be able to shift gears while the transmission is disengaged. In this manner, damage to the gears of the transmission is avoided. The clutch pedal is used to disengage the clutch, which is basically a friction coupling placed between the engine and the transmission. The components of such an arrangement are subject to wear, including the friction surfaces of the clutch. Furthermore, many drivers consider the necessity of manually depressing a clutch pedal while gear shifting to be unacceptably inconvenient. A manually operated clutch also has the disadvantage that the smoothness of engagement depends upon the skill of the operator. These factors have lead to the widespread use of automatic transmissions that do not require the operation of a clutch pedal. However, the convenience of an automatic transmission comes also with well-known disadvantages in terms of performance, fuel efficiency, emissions, complexity, longevity and costs that are substantially higher than a comparable manual transmission.

While transmissions have been developed that shift automatically in response to certain predefined events, the difficulty of automatically disengaging and engaging a friction clutch for repeatable smooth performance has achieved limited acceptance. It remains a need in the pertinent art to provide a clutching arrangement that overcomes the operator perceived inconveniences associated with a manual transmission while retaining the noted advantages of a manual transmission.

### SUMMARY OF THE INVENTION

The present teachings provide a clutching arrangement and control logic which adapt a manual transmission to provide convenient manual shifting without the need to manually operate a conventional pedal.

The present teachings provide a clutching arrangement and control logic for a manual transmission that provides the driver full control of shifting speeds for desired performance. It will at the same time provide a level of driving convenience and smoothness of operation comparable with an automatic transmission without clutch pedal operation.

The present teachings provide a clutching arrangement and control logic for a manual transmission that will retain the higher fuel efficiency and lower emissions levels associated with the use of a manual transmission, but will at the same time provide a level of driving convenience comparable with an automatic transmission without clutch pedal operation.

The present teachings provide a clutching arrangement and control logic for a manual transmission that will still provide the simplicity, longevity and reliability of a manual transmission, but will at the same time provide a level of driving convenience comparable with an automatic transmission without clutch pedal operation.

The present teachings provide a clutching arrangement and control logic for a manual transmission that will not depend on human operation for the speed of engagement, but instead will put the vehicle's computer in control for the speed of engagement, thereby optimizing such engagement speed to avoid too abrupt an engagement which can damage engine, clutch or transmission parts, or too slow an engagement which can slip and damage the friction linings of the clutch as well as provide insufficient vehicle acceleration.

The present teachings provide a clutching arrangement and control logic for a manual transmission that will be free of the wear inherent in conventional friction clutches and therefore will not require service or replacement of friction surfaces or other wear components.

The present teachings provide a clutching arrangement and control logic for a manual transmission that will be operator fool-proof; i.e., it cannot be damaged by the operator's actions or habits (such as resting a foot on the clutch pedal while driving, which can lead to rapid wear and failure in a conventional clutch.)

The present teachings provide a clutching arrangement and control logic for a manual transmission that will improve the performance of transmissions that shift automatically in response to predefined events by providing smooth, controlled and precise engagement of the clutch on a repeatable basis regardless of operating conditions.

The present teachings provide a clutching arrangement and control logic for a manual transmission that includes a synchronizer arrangement that can eliminate the individual synchronizers of each gear set of a conventional transmission.

The present teachings provide a clutching arrangement and control logic for a manual transmission that eliminates the requirement for a torsional dampener that is conventionally incorporated in the clutch plate of a standard dry-friction clutch.

In one aspect, the present teachings provide a clutching arrangement for transferring power from an output shaft of an engine to an input shaft of a manual transmission. The clutching arrangement includes a housing and an electrically controlled clutch mounted in the housing The clutch selectively couples and uncouples the output shaft and the input shaft. The clutch arrangement further includes a clutch synchronizer disposed between the input shaft and the output shaft for synchronizing a speed of the input shaft with a speed of the output shaft.

In another aspect, the present teachings provide a clutching arrangement for transferring torque between a first drive member and a second-drive member, the clutching arrangement includes an input assembly for coupling to the first drive member and an output assembly for coupling to the second drive member. The output assembly is selectively coupled to the input assembly. The clutching arrangement further includes a magneto rheological fluid (MRF) disposed between the input assembly and the output assembly. The MRF is operable to normally permit relative rotation between the input assembly and the output assembly and operable upon activation to selectively couple the input assembly and the output assembly.

In another aspect, the present teachings provide a method of selectively transferring torque between a first member and a second member. The method includes the step of providing a clutching arrangement having an input assembly coupled to the first member and an output assembly coupled to the second member. The clutching arrangement additionally includes MRF disposed between the input assembly and the output assembly. The MRF is operable to normally permit relative rotation between the input assembly and the output assembly and operable upon activation to selectively couple the input assembly and the output assembly. The method further includes the step of activating the MRF to selectively couple the input assembly and the output assembly.

Further areas of applicability of the present invention will become apparent from the detailed description provided hereinafter. It should be understood that the description and specific examples below, while indicating particular embodiments of the invention, are intended for purposes of illustration only and are not intended to limit the scope of the invention.

Additional benefits and advantages of the present invention will become apparent to those skilled in the art to which this invention relates from a reading of the subsequent discussion of the present teachings and the appended claims, taken in conjunction with the accompanying drawings.

### BRIEF DESCRIPTION OF THE DRAWINGS

The present invention will become more fully understood from the detailed description and the accompanying drawings, wherein:

FIG. 1 is a cross-sectional view of a transmission clutch according to the teachings of the present invention.

FIG. 2A is an enlarged cross-sectional view of a portion of FIG. 1.

FIG. 2B is an enlarged cross-sectional view of a portion of FIG. 1.

FIG. 2C is an enlarged cross-sectional view of a portion of FIG. 1.

FIG. 3 is an enlarged cross-sectional view of a portion of FIG. 1.

FIG. 4 is a cross-sectional view similar to FIG. 1, illustrating an alternate method of connecting a battery to the clutch coils is shown.

### DISCUSSION

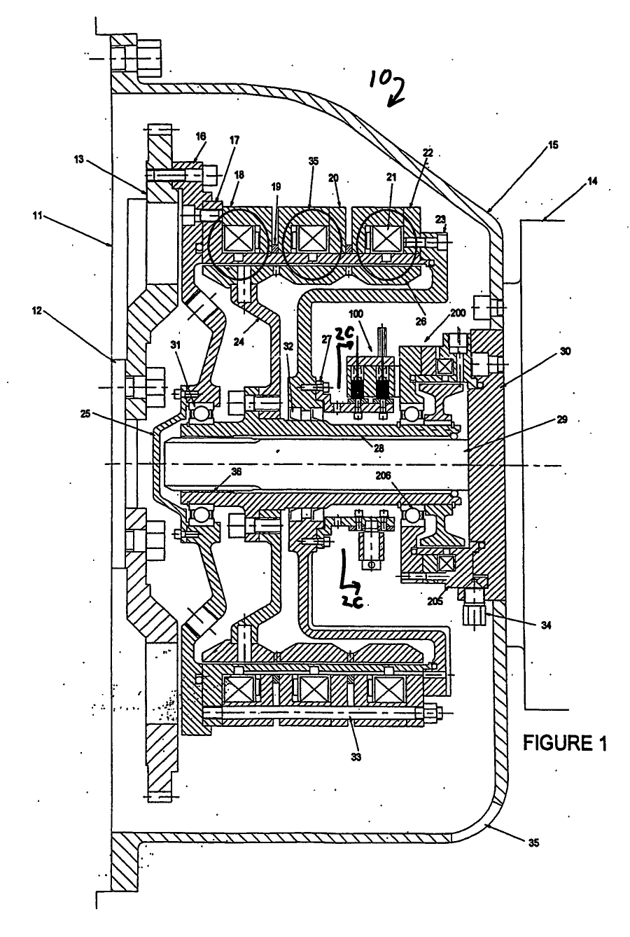

With initial reference to FIG. 1, a vehicle transmission clutch or clutch assembly with integral synchronizer constructed in accordance with the present teachings is illustrated and generally identified at reference 10. It will be appreciated that the particular embodiment shown is merely exemplary in nature and is in no way intended to limit the invention, its application, or uses.

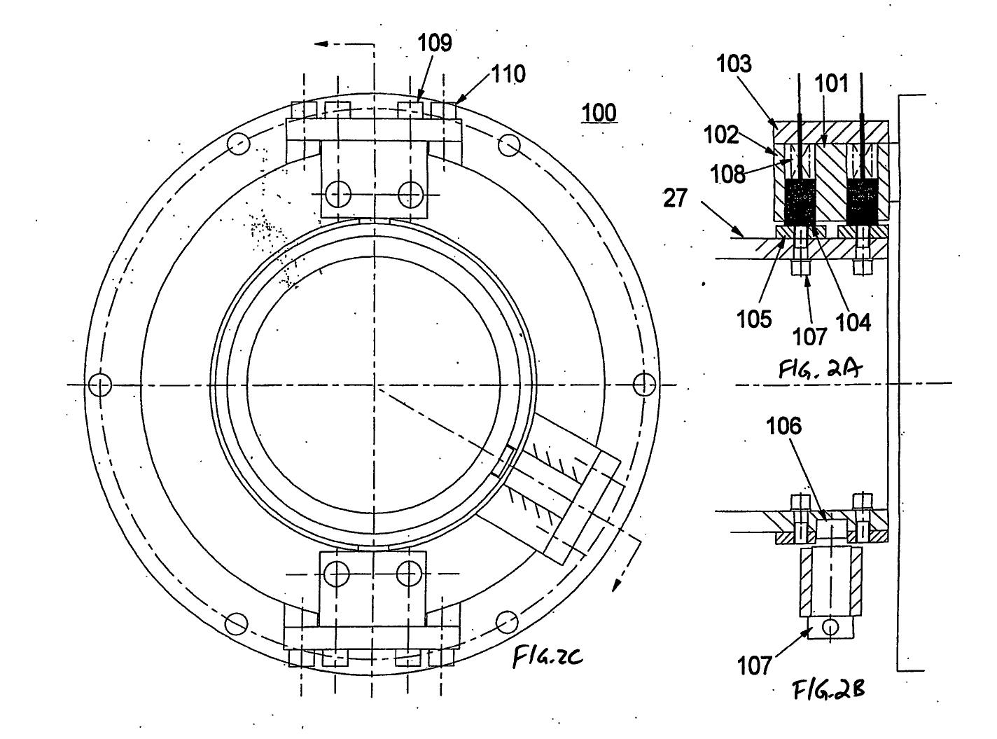

With continued reference to FIG. 1 and additional reference to FIGS. 2A-2C, the transmission clutch 10 is illustrated to generally include a flywheel 13 mounted to crankshaft 12 of an internal combustion engine 11. A bell housing 15 of the transmission clutch 10 may be bolted or otherwise suitably attached to the internal combustion engine 11 on the flywheel end and to a manual transmission on an opposite end. A small amount of magneto rheological fluid (MRF) may be contained within the clutch portion. The volume of the MRF may be sufficient to fill a gap defined by the inside diameter of a clutch stator 17 and the outside diameter of a clutch rotor 26. A plurality of clutch coils 21 may be connected in parallel to a slip ring 27. When current from a battery of the vehicle is applied to the coils 21, flux fields 35 may be generated and the clutch 10 may be capable of transmitting engine torque to the transmission.

The clutch 10 may include a drive flange 16 which can be constructed of aluminum or other non-magnetic material. The drive flange 16 may be bolted or otherwise suitably attached to the flywheel 13. The stator 17 may be attached to the drive flange 16 in the embodiment illustrated and may be constructed of low carbon steel, for example. Coil housings 18 and coil covers 20 and 22 may be mounted to the outside diameter of the clutch stator 17 and define the cavities that accept the coils 21. The coil housings 18 and coil covers 20 and 22 may be constructed of low carbon steel, for example.

Spacers 19 may be disposed between adjacent housings and covers 20 and 22. The spacers 19 may be be constructed of aluminum or other non-magnetic material and serve to keep flux fields 35 from mutual interference. The coils 21, coil housings 18, coil covers 20 and 22 and spacers 19 may be mounted on the clutch stator 17 and secured together by studs and nuts 33 to make an integral sub-assembly. This clutch stator sub-assembly may rotate with the engine flywheel 13. As will be appreciated by those skilled in the art, the total inertia of the flywheel 13 and clutch stator sub-assembly must be controlled within precise limits.

Multiple coils 21 may be used in particular applications to lower the total area of low carbon steel surrounding the coils and thereby provide proper flux density for a specific clutch torque rating. In this manner, the coils 21 may enable the arrangement to meet the total flywheel and stator sub-assembly inertia requirements. A further potential benefit of multiple coils 21 is the reduction of total electrical amperage as compared to a single coil for the same torque rating. It will be appreciated by those skilled in the art, however, that most applications need only employ a single coil 21.

The clutch 10 may include a torque tube 28 supported on one end by a bearing 31 mounted in the drive flange 16. On its other end, the torque tube 28 may be supported by a bearing 206 in a synchronizer sub-assembly 200. A hub 24 may be bolted to a flange integrally formed on the torque tube 28. A rotor 26 may be doweled to this hub 24. One end of the torque tube 28 may contain an internal spline 36 that mates with a spline on the input shaft of the transmission 14. A cover 25 may seal one end of the clutch 10.

A clutch cover 23 may be constructed of aluminum or other non-magnetic material and may be attached to a coil cover 22 by screws or other suitable means. A seal 32 may mount in the inner bore of the clutch cover 23 and seal the other end of the clutch 10. The clutch cover 23 may also supports the slip ring 27.

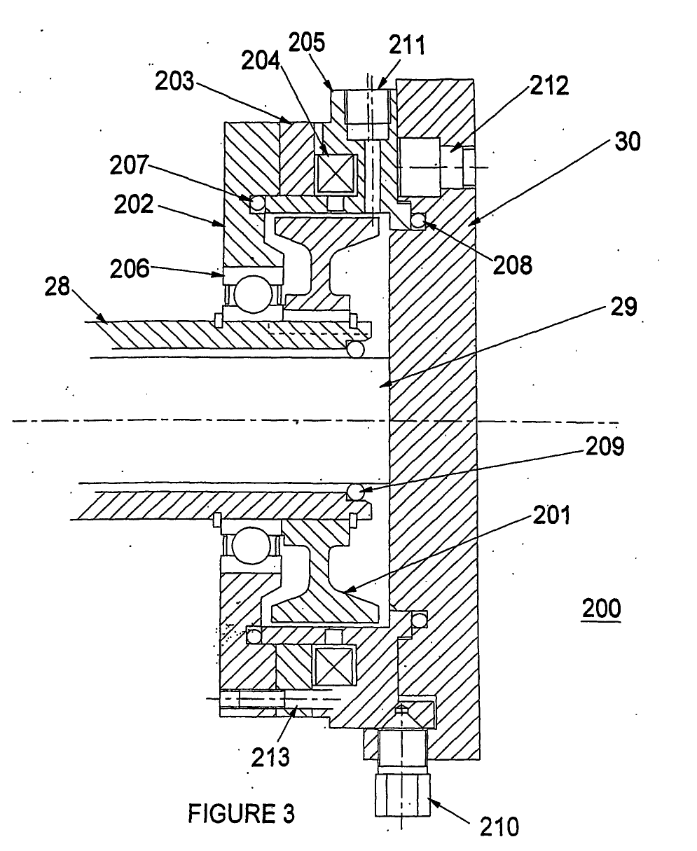

Particular reference is now made to FIGS. 2A-2C. The wires from the coils 21 may be secured to the slip ring 27 by screws 107. The main body of the slip ring 27 can be plastic, for example. Bronze rings 105 may be secured to this body by the screws 107. The stationary housing of the slip ring 27 may consist of two brush retainers 102 that may be slotted to accept two sets of brushes 104 at 180 degrees and can be plastic, for example. A center ring 101 may be also made of plastic. These three parts may be held together by screws 109 attaching then to plastic plates 103. The plastic plates 103 are attached to bearing plate 202 (shown in FIG. 3) by screws 110. Springs 108 may provide pressure to the brushes 104 for proper seating to the bronze rigs 105. Two sets of brushes 104 may be used to reduce amperage flow and thereby their life.

A Hall sensor 107 may also mounted on the center ring 101. A magnetic target 106 may be mounted in the main body of the slip ring 27. Engine speed and thus input speed to the clutch 10 is already monitored by the engine control electronics in a conventional manner. The Hall sensor 107 may monitor the output speed of the clutch 10 that is used for several control functions as described below.

With particular reference to FIG. 3, an enlarged cross-sectional view of the synchronizer 200 is provided. In the embodiment illustrated, the synchronizer 200 may be a brake-type assembly that uses the same magneto rheological fluid (MRF) technology as the clutch 10. It will be appreciated by those skilled in the art, however, that a conventional friction-type synchronizer arrangement may be alternatively used within the scope of the present invention. MR fluid may be added to this section of the assembly 10 through a port 211. The amount of MR fluid used may be sufficient to fill the annulus gap defined by an inside diameter of a brake stator 205 and the outside diameter of a brake rotor 201.

The stator 205 may contain a coil 204. The stator 205, an intermediate plate 203 and the brake rotor 201 may be made of low carbon steel. The brake rotor 201 may be conventionally secured to the torque tube 28 by a key and retaining ring. The brake rotor 205, the intermediate plate 203 and the bearing plate 202 may be held together by screws 213. O-rings 207, 208 and 209 may provide static seals to retain the MR fluid within the synchronizer 200. The housing 30 may be part of the transmission 14 and may contain a bearing for the transmission input shaft 29. The coil 204 may provide braking torque generally proportional to the amount of current applied. As noted above, a synchronizer based on conventional dry-friction technology can alternatively perform the same function as a MR fluid technology synchronizer as just described. Such conventional technology would, however, potentially be less durable.

Particular reference is again made to FIG. 1 to explain the sequence of assembly of the present clutch 10 to a vehicle. The flywheel 13 may be first assembled onto the engine crankshaft. The bell housing 15 may be mounted to the transmission 14. All other elements of the present invention may be pre-assembled as an integral unit. This integral unit may be assembled onto the flywheel 13 and secured by screws, for example. The transmission shaft 29 (which is an integral part of the transmission) may be inserted into the torque tube 28 and guided as its spline enters the internal spline of the torque tube 28. The pilot diameter of the brake stator 205 may contact the housing 30 of the transmission 14. This engagement can be observed through holes 35 in the bell housing 15. The bell housing 15 is now attached to the engine 11. Two screws 34 may be used to secure the brake stator 205 to the housing 30. The holes 35 and a wrench or other suitable tool are used for this purpose. The screws 34 may be threaded into the housing 30 and may have a cone-shaped end that mates with a conical cavity in the brake stator 205.

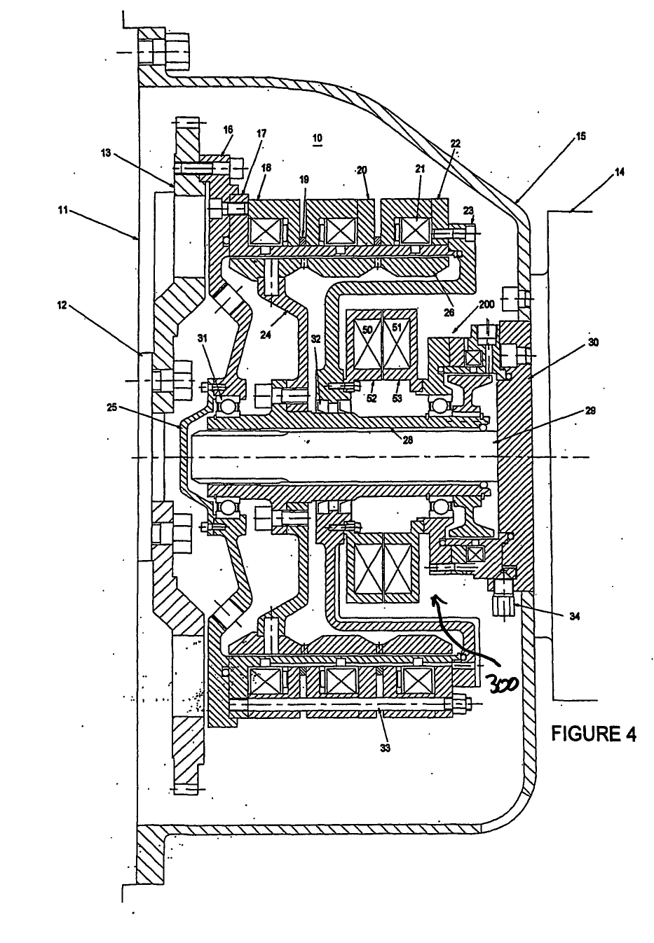

Reference will now be made to the alternative construction of FIG. 4. In certain applications, it may be desirable to conduct the electric current to the clutch coils 21 without physical contact between mechanical parts (and therefore subject the parts to wear). As a non-wear alternative to the slip ring arrangement described above, a rotary transformer 300 such as shown in FIG. 4 may be incorporated for delivering electric current to the clutch coils 21. The rotary transformer 300 many include a coil 50 and its housing 52 that rotate with the clutch coils 21. The rotary transformer 300 may further include a coil 51 and its housing 53 that are stationary. Additionally, the rotary transformer 300 may have other electronic components not shown but conventional in the art. The coil 50 may be connected to the clutch coils 21 and the coil 51 is connected to the battery of the vehicle. Electrical current may be transmitted from the battery to the clutch coils 21 by the inductive action of the coils 50 and 51.

The torque transmitted by the clutch 10 is generally proportional to the applied current to the coils 21. If enough current is applied to these coils 21, there is no slippage between input and output of the clutch. In other words, the transmission input shaft 29 rotates at exactly the same speed as the flywheel 13. It will be appreciated by those skilled in the art that the current to the coils 21 may be modulated.

Conventional dry-friction automotive clutches incorporate a torsion-dampening device. One function of this device is to soften the so-called “rooster-tail” or rapid torque increase during the transition from dynamic to static operation. The clutch 10 described herein does not exhibit such torque peaking since the MRF transmits the torque. The other function of the torsion dampener is to soften road-induced shocks. Conventional dry-friction automotive clutches are engaged by springs of such force that they are rated at approximately twice the actual torque required.

The clutch torque of the present invention can be kept just above the actual torque required for the “real-time” operating condition. In this regard, a Hall sensor 107 may continuously monitors the output speed of the clutch 10 and compares it to the engine speed. During acceleration of the vehicle, the current to the clutch coils 21 may be increased by the an engine control module to just above “no-slip”. Sensors conventionally installed on the vehicle for other purposes sense when acceleration is completed and the clutch coil current is reduced until the output speed is just under the input speed and then increased slightly for “no-slip”. With clutch torque just above required torque, the clutch 10 may be permitted to slip slightly when road-induced shock occurs and thereby eliminates the need for a separate torsion-dampening device.

Current is normally applied to the clutch coils 21 when the engine 14 is running except when the transmission 14 is in a neutral position. Depressing the brake pedal may also disconnect current to the coils 21. The clutch 10 is disengaged for shifting between gears in the transmission by opening a switch in the electrical leads to the brushes 104. This clutch-disengage switch may be incorporated in the transmission shift lever and can be held depressed during shifting. The clutch control module knows the present ratio when the clutch is disengaged for shifting. Using this information and the vehicle speed, the module may calculate the required speed of the transmission input shaft 29. Either the clutch coils 21 may be energized if the speed is too slow or brake coil 204 if too fast. This reduces the wear and tear on the synchronizers built into each gear ratio of the transmission and in fact, can completely eliminate them. After shifting is complete, the clutch-disengage switch may be released.

Each shift command from the driver may generate an electrical signal to engage or disengage the clutch 10. The electrical signal may also activate the clutch synchronizer 200 to allow a smooth shift of the manual transmission. The vehicle computer may coordinate and synchronize the total process.

An algorithm may be resident in the engine control module or clutch control module that controls the rate current is applied to the clutch coils 21 for a smooth engagement. Optionally, this algorithm may include provisions for the ability of the vehicle operator to change the speed of clutch engagement to various defined rates. For example, a “sports” version would have aggressive, but smooth clutch engagement while a “cruise” version would have less aggressive engagement. The algorithm may automatically controls torque just above the torque required to drive the output of the clutch 10 at the same speed as the engine speed under all operating conditions. Slight clutch slippage cushions any road shock, thereby eliminating the need for other mechanism, such as dampers. The algorithm automatically increases the clutch torque smoothly to provide proper acceleration and simultaneously meet the previously described conditions in which torque is just above the required torque. By automatically adjusting the speed of the driving gear in the engine to the speed of the driven gear in the transmission, engagement of gears is smooth and without clashing of teeth. Synchronization may be accomplished by selectively energizing the coils of the clutch 10 or the coil of the synchronizer brake. In certain applications, it may be desirable for the algorithm to provide for vehicle creep when the engine is operating at idle speed so as to create further driving convenience in stop and go traffic.

The electronic clutching of the present teachings may eliminate the need for a clutch pedal. Depressing and releasing a clutch pedal many times in heavy urban traffic is tiring and an important reason for the widespread use of automatic transmissions. If a clutch pedal is desired because of operator preference, the usual levers and links that connect it to the clutch are eliminated. The pedal may serve to only operate a switch. A light spring may also be incorporated to give the operator some “feel” in its operation.

An alternative for automatic transmissions is the electronic shifted manual transmission. These offer the convenience of automatic transmissions with the added benefits of better gas mileage and better durability. These electronically shifted manual transmissions have used dry-friction clutches—the same type used on a manually shifted transmission. They have been modified to be electrically operated using various schemes but the inherent wear and instability of the dry-friction technology sacrifice the performance of electronic shifted manual transmissions and have thus limited their acceptance. The mating of the present teachings with these transmissions will significantly improve the performance and durability of these systems. The electronic shifted manual transmissions can be programmed to respond automatically to specific and changing operating conditions to make them competitive with the automotive transmissions. Alternatively, manually selected switches such as paddles on the steering wheel can initiate electronic shifting. The present invention enhances the performance of either control strategy.

The description of the present teachings is merely exemplary in nature and, thus, variations that do not depart from the gist of the invention are intended to be within the scope of the invention. Such variations are not to be regarded as a departure from the spirit and scope of the invention.

What is claimed:

1. A clutching arrangement for transferring power from an output shaft of an engine to an input shaft of a manual transmission, the clutching arrangement comprising:
a housing;
an electrically controlled clutch mounted in the housing, the clutch for selectively coupling and uncoupling the output shaft and the input shaft; and
a clutch synchronizer disposed between the input shaft and the output shaft for synchronizing a speed of the input shaft with a speed of the output shaft.

2. A clutching arrangement for transferring power of claim 1, wherein the clutch is a magneto rheological fluid (MRF) clutch having MRF which is activated for selective coupling of the input shaft to the output shaft.

3. A clutching arrangement for transferring power of claim 1, wherein the clutch synchronizer is a friction brake that is selectively and adaptively applied to slow down the output shaft to equalize its speed with the input shaft.

4. A clutching arrangement for transferring power of claim 1, wherein the synchronizer is a magneto rheological fluid brake that is selectively and adaptively applied to slow down the output shaft to equalize its speed with the input shaft.

5. A clutching arrangement for transferring power of claim 1 further comprising an Electronic Control Module (ECM) for coordinating and synchronizing operation of the clutch and synchronizer.

6. A clutching arrangement for transferring power of claim 1, wherein the clutch is automatically disengaged when a brake pedal is depressed.

7. The clutching arrangement for transferring power of claim 5, wherein the ECM is operable to automatically control torque just above the torque required to drive an output of the clutch at same speed as the input shaft under normal operating conditions.

8. The clutching arrangement for transferring power of claim 7, wherein the ECM operates to permit clutch torque transfer rates in response to a driver selection.

9. A clutching arrangement for transferring torque between a first drive member and a second drive member, the clutching arrangement comprising:
an input assembly for coupling to the first drive member;
an output assembly for coupling to the second drive member, the output assembly selectively coupled to the input assembly; and
a magneto rheological fluid (MRF) disposed between the input assembly and the output assembly, the MRF operable to normally permit relative rotation between the input assembly and the output assembly and operable upon activation to selectively couple the input assembly and the output assembly.

10. The clutching arrangement for transferring power of claim 9, further comprising at least one coil for activating the MRF.

11. A clutching arrangement for transferring power of claim 10, further comprising:
a first sensor for monitoring an output speed of the first drive member;
a second sensor for monitoring an input speed of the first and second drive member;
a control arrangement for comparing the output speed with the input speed and accordingly varying a current delivered to the at least one coil.

12. A method of selectively transferring torque between a first member and a second member, the method comprising the steps of:
providing a clutching arrangement having an input assembly coupled to the first member and an output assembly coupled to the second member, the clutching arrangement additionally having MRF disposed between the input assembly and the output assembly, the MRF operable to normally permit relative rotation between the input assembly and the output assembly and operable upon activation to selectively couple the input assembly and the output assembly; and
activating the MRF to selectively couple the input assembly and the output assembly.

13. The method of claim 12, further comprising the steps of:
providing at least one coil; and
delivering an electrical current to the at least one coil to activate the MRF.

14. The method of claim 12, further comprising the step of varying the current delivered to the at least one coil.

15. The method of claim 14, further comprising the steps of:
comparing an output speed of the first drive member with an input speed of the second drive member; and
varying the current delivered to the at least one coil as a function of the compared value of the output speed and the input speed.

16. The clutching arrangement for transferring power of claim 1, further comprising a driver controlled switch that is actuated upon manually shifting between transmission ratios.

17. The clutching arrangement for transferring power of claim 16, further comprising a shift stick, the switch located on the shift stick.

18. A clutching arrangement for transferring power of claim 1, further comprising a slip ring assembly for providing electric connection between a vehicle battery and the at least one coil.
